(19) United States
(12) Patent Application Publication
(10) Pub. No.: US 2004/0176235 A1
(43) Pub. Date: Sep. 9, 2004

(54) Ceramic material and optical device including the same

(76) Inventor: Akihiko Sakamoto, Shiga (JP)

Correspondence Address: WILLIAM COLLARD, COLLARD & ROE, P.C., 1077 NORTHERN BOULEVARD, ROSLYN, NY, 11576, US

(21) Appl. No.: 10/482,619

(22) PCT Filed: Jun. 28, 2002
(86) PCT No.: PCT/JP02/06569

(30) Foreign Application Priority Data
Jun. 28, 2001 (JP) 2001-197106

(51) Int. Cl. C03C 10/12; C03C 10/06; C03C 10/08

(52) U.S. Cl. 501/7; 501/8; 501/9

(57) ABSTRACT

A ceramic material has a thermal expansion coefficient of 50×10⁻⁷/° C. or less, an absolute value of the difference between the relative refractive indexes of silica glass and the ceramic material of 0.2 or less at a wavelength of 1550 nm, and a light attenuation coefficient of 0.3 dB/cm or more.

### TECHNICAL FIELD

The present invention relates to optical devices and, more specifically, it relates to a ceramic material applicable to an optical communication device and relates to an optical device.

### BACKGROUND ART

In the field of optical communication using light having wavelengths in the infrared region, a large amount of silica glass having a large infrared transmittance is used for waveguides, typified by optical fibers, for conducting light in a predetermined state.

A large number of optical devices comprising silica glass as a fabrication material are required in this field. Exemplary optical devices include optical connectors, optical attenuators, planar light circuits (PLC), and arrayed waveguides (AWG). Fabrication materials for these optical devices are selected from metals, semimetals, resins, and ceramics (including glass and crystallized glass), in addition to silica glass, according to the application and purpose.

These materials are used for waveguide-adjacent members adjacent to waveguides comprising silica glass, that is, materials adjacent to a cladding portion of waveguide devices such as optical fibers, planar light circuits, and arrayed waveguides. In particular, these materials are used for ferrules of optical connectors or optical attenuators and are used for substrates of planar light circuits, arrayed waveguides, or the like. The term adjacent used herein is also used for expressing a state in which one thing is adjacent to another thing with a layer comprising, for example, an adhesive agent-therebetween, in addition to a state in which two things touch directly.

In conventional optical devices, since silica glass is used for conducting light, it has not been necessary for waveguide-adjacent members to have optical functions. However, because optical devices having higher performance have been desired, the effect of light slightly leaking out of a waveguide comprising silica glass is significant. That is, light leaking out of a core portion of a waveguide is conducted in a cladding portion to cause interference with signal light, and this may result in deterioration in the device performance. In such a case, it is an important object to prevent light conducted in the cladding portion (cladding mode) from causing interference with signal light conducted in the core portion (core mode). Accordingly, it is necessary for a waveguide-adjacent member for optical devices having high performance to have some optical functions in order to achieve the above object.

In optical devices, the properties of waveguide-adjacent members occasionally have an influence on the waveguide characteristics and the conducting characteristics of optical signals from optical devices. In order that an optical device has predetermined performance, the following characteristics are particularly important: for example, the mechanical characteristics of ferrules used in optical connectors and optical attenuators, the thermal characteristics of substrates used in PLCs and AWGs, and the like. That is, it is required for a waveguide-adjacent member to have a high stiffness against external forces in order to prevent the deformation of the waveguide, and to have a thermal expansion coefficient close to that of silica glass in order to prevent the deterioration of the device characteristics due to heat stress.

As shown in FIG. 1, in order to prevent interference caused by leakage light 22 leaking out of a waveguide 21, a waveguide-adjacent member 20 is required to suppress the reflection of light at an interface 24 between a waveguide member 23 and the waveguide-adjacent-member 20. When the interface 24 between the waveguide member 23 and the waveguide-adjacent member 20 has a large reflectance, reflected light 25 returns into the waveguide 21 to cause interference with signal light 26, Generally, since light reflection is due to the difference between the refractive indexes of two materials forming an interface, the waveguide-adjacent member 20 is required to have a refractive index close to that of the waveguide member 23.

On the other hand, when the leakage light 22 from the waveguide 21 is not reflected by the interface 24 between the waveguide member 23 and the waveguide-adjacent member 20 and thus enters the waveguide-adjacent member 20, there may be cases where incident light 27 is conducted in the waveguide-adjacent member 20 and is reflected by an air-side interface 28 to return into the waveguide 21. In this case, it is necessary to sufficiently attenuate the incident light 27 in the waveguide-adjacent member 20 so as not return into the waveguide member 23. Thus, the waveguide-adjacent member 20 should comprise a material having a large light attenuation coefficient.

Disclosure of Invention

It is an object of the present invention to provide a ceramic material that efficiently attenuates light leaking out of a waveguide member and prevents interference with signal light and to provide an optical device including the same.

The inventor has found that a ceramic material having a smaller thermal expansion coefficient and a higher stiffness than those of other materials is suitable for the waveguide-adjacent member. In addition, the inventor has clarified the relationship between the behavior of light leaking out of a waveguide and the characteristics of the materials. The inventor has consequently achieved the intended objects by using a ceramic material for the waveguide-adjacent member, wherein the ceramic material has a small thermal expansion coefficient, a small absolute value of the difference between the relative refractive indexes of silica glass and the ceramic material, and a large light attenuation coefficient. Thus, the inventor proposes this invention.

According to an aspect of the present invention, there is provided a ceramic material which has a thermal expansion coefficient of less than 50×10⁻⁷/° C., an absolute value of the difference between the relative refractive indexes of silica glass and the ceramic material of 0.2 or less at a wavelength of 1550 nm, and a light attenuation coefficient of 0.3 dB/cm or more.

It may be arranged that the ceramic material is made of crystallized glass.

It may be arranged that the ceramic material comprises SiO₂, Al₂O₃, and Li₂O in a total amount of 45% or more on the basis of mass percentage.

It may be arranged that the thermal expansion coefficient is less than 40×10⁻⁷/° C.

It may be arranged that the light attenuation coefficient is of 0.5 dB/cm or more.

According to another aspect of the present invention, there is provided an optical device comprising any one of the above-mentioned ceramic materials.

When used for a waveguide-adjacent member adjacent to a waveguide member in the optical device, the ceramic material effectively absorbs light leaking out of a waveguide to attenuate it. Interference between a cladding mode and a core mode can be prevented. Accordingly, the ceramic material is excellent for improving the performance of optical devices such as fixed attenuators.

### BRIEF DESCRIPTION OF DRAWINGS

FIG. 1 is a conceptual illustration showing the behavior of light leaking out of a waveguide.

FIG. 2 is a longitudinal sectional view of a fixed attenuator comprising a ceramic material according to the present invention.

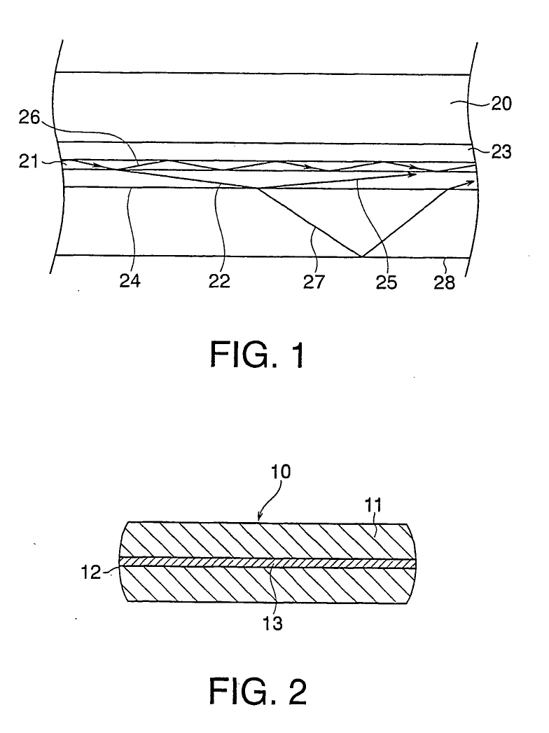

### BEST MODE FOR CARRYING OUT THE INVENTION DESCRIPTION

Description will be made as regards a ceramic material according to an embodiment of the present invention.

In the ceramic material, a thermal expansion coefficient is determined less than 50×10⁻⁷/° C. An absolute value of the difference between the relative refractive indexes of silica glass and the ceramic material is determined of 0.2 or less at a wavelength of 1550 nm. A light attenuation coefficient is determined of 0.3 dB/cm or more.

The description will be directed to optical devices each comprising a waveguide member of silica glass and a waveguide-adjacent member which is adjacent to the waveguide member and is made of the ceramic material.

Since the thermal expansion coefficient of the ceramic material is of less than 50×10⁻⁷/° C., thermal stress arising between the waveguide member and the waveguide-adjacent member is small. Therefore, the ceramic material can be used for optical devices. The thermal stress arising between the waveguide member and the waveguide-adjacent member depends on the thicknesses and the lengths of both the materials and becomes large in proportion to these dimensions. When the thermal expansion coefficient of the waveguide-adjacent member is less than ten times as large as that of silica glass, the main characteristics of optical devices are not affected in practice. It is preferable that the thermal expansion coefficient of the ceramic material is determined less than 40×10⁻⁷/° C.

Since the absolute value of the difference between the relative refractive indexes of silica glass and the ceramic material is of 0.2 or less at a wavelength of 1550 nm, the interface between the waveguide-member and the waveguide-adjacent member has a small infrared reflectance. Therefore, light leaking out of the waveguide member is not reflected by the interface between the waveguide member and the waveguide-adjacent member and almost all of the light enters the waveguide-adjacent member. Thus, no reflected light returns into the waveguide member to cause interference with signal light. That is, a situation in which the absolute value of the difference between the relative refractive indexes of silica glass and the ceramic material is 0.2 or less means that the difference between the refractive indexes of silica glass and the waveguide-adjacent member is small. Therefore, the reflectance of the interface between the waveguide member and the waveguide-adjacent member is extremely small over a wide range of incident angles, and the reflectance at other regions is also significantly reduced.

In general, a refractive index difference is expressed by the absolute value (D) of the relative refractive index difference defined by the following formula:

D=|(n₁−n₂)/n₁|,

wherein n₁ represents the refractive index of the cladding portion of the waveguide member and n₂ represents the refractive index of the waveguide-adjacent member. Since infrared light is used in optical communication, the refractive index at a wavelength of 1550 nm is used herein.

In the ceramic material, the light attenuation coefficient is of 0.3 dB/cm or more at a wavelength of 1550 nm. Therefore, light which has not been reflected by the interface between the waveguide member and the waveguide-adjacent member to enter the waveguide-adjacent member is sufficiently attenuated, and does not thus return into the waveguide member. It is preferable that the light attenuation coefficient is determined of 0.5 dB/cm or more.

The light attenuation coefficient L of a waveguide-adjacent member is represented by the following formula:

L=10 log(I₀/I),

wherein I₀/I represents the ratio of the incident light intensity I₀ to the transmitted light intensity I when light is transmitted through a waveguide-adjacent member having a thickness of 1 cm.

The amount of attenuated light depends on the dimensions of waveguide-adjacent members and the dimensions and structures of optical devices, and materials having a large light attenuation coefficient attenuate light efficiently. Because the light attenuation coefficient depends on wavelength, the light attenuation coefficient at a wavelength of 1550 nm is used herein.

A ceramic material having the above characteristics is preferably crystallized glass, phase separated glass in which different glass phases coexist, or sintered ceramic. Crystallized glass is particularly preferable due to the following reasons. The thermal expansion coefficient is controllable over a wide range by selecting a precipitated crystal. A refractive index that is close to that of silica glass can be imparted to the crystallized glass, which has glass-like properties. The light attenuation coefficient is also controllable by adjusting the amount and the grain size of the precipitated crystal and the refractive index.

For the crystallized glass described above, crystallized glass containing Li₂O—Al₂O₃—SiO₂, MgO—Al₂O₃—SiO₂, or ZnO—Al₂O₃—SiO₂ is preferable, and Li₂O—Al₂O₃—SiO₂ crystallized glass having a total Li₂O, Al₂O₃, and SiO₂ content of 45% by mass or more is particularly preferable. Specifically, an exemplary range of the composition is 40-73% of SiO₂, 15-30% of Al₂O₃, 1.5-6% of Li₂O, the balance being up to 35% according to need, on the basis of mass percentage, the balance being TiO₂, ZrO₂, P₂O₅, MgO, ZnO, BaO, Na₂O, K₂O, CaO, SrO, B₂O₃, Sb₂O₃, SnO, and As₂O₃. At least one of a β-spodumene solid solution, a β-quartz solid solution, β-spodumene, and β-eucryptite is precipitated as a main crystal.

In the MgO—Al₂O₃—SiO₂ crystallized glass, a β-quartz solid solution, cordierite, or spinel is precipitated as a main crystal. In the ZnO—Al₂O₃—SiO₂ crystallized glass, a β-quartz solid solution, gahnite, or Zn-petalite is precipitated as a main crystal.

For the phase-separated glass, glass containing B₂O₃—Al₂O₃—SiO₂, Na₂O—Al₂O₃—SiO₂, or P₂O₅—SiO₂ is preferable. For the sintered ceramic, a ceramic containing Al₂O₃, Li₂O—Al₂O₃—SiO₂, MgO—Al₂O₃—SiO₂, or ZnO—Al₂O₃SiO₂ is preferable.

A waveguide-adjacent member of a fixed attenuator must comprise a cylindrical material having a high dimensional accuracy within ±0.5 μm with respect to both the outer and inner diameter. Therefore, crystallized glass is preferable because this high dimensional accuracy can be achieved. Specifically, such crystallized glass contains 60-70% of SiO₂, 16-25% of Al₂O₃, 1.5-3% of Li₂O, 0.5-2.5% of MgO, 1.3-4.5% of TiO₂, 0.5-3% of ZrO₂, 2-6.5% of TiO₂+ZrO₂, 1-5.5% of K₂O, 0-7% of ZnO, and 0-3% of BaO, on the basis of mass percentage. In the crystallized glass, a β-spodumene solid solution or a β-quartz solid solution is precipitated in an amount of 30-70% by volume. For the crystallized glass, hot-drawing processing is applicable and the processing accuracy described above can be achieved.

The ceramic material will now be described based on examples below.

Table 1 shows the composition of Examples 1-5 and Table 2 shows the composition of Examples 6-8. Table 3 shows the characteristics of Examples 1-5 and Table 4 shows the characteristics of Examples 6-8 and Comparative Examples 9-10.

TABLE 1

| | EXAMPLES | | | | |
|---|---|---|---|---|---|
| (mass %) | 1 | 2 | 3 | 4 | 5 |
| SiO₂ | 65 | 68 | 64 | 50 | 65 |
| Al₂O₃ | 18 | 16.5 | 22 | 27 | 15 |
| Li₂O | 2.5 | 2.5 | 4 | — | — |
| MgO | 1 | 2 | 0.5 | 12 | — |
| ZnO | 3 | 1 | — | — | 20 |
| K₂O | 4 | 2.5 | 1 | — | — |
| TiO₂ | 3 | 3 | 2 | 11 | — |
| ZrO₂ | 2 | 2 | 3 | — | — |
| BaO | 1.5 | 2.5 | — | — | — |
| Na₂O | — | — | 1.5 | — | — |
| P₂O₅ | — | — | 2 | — | — |
| main | β- | β-quartz | β- | cordierite | Zn-petalite |
| Crystalline | spodumene | solid | spodumene | | |
| phase | solid | solution | solid | | |
| | solution | | solution | | |

TABLE 2

| | EXAMPLES | | |
|---|---|---|---|
| (mass %) | 6 | 7 | 8 |
| SiO₂ | 67 | 69 | 50 |
| Al₂O₃ | 9 | 12 | 30 |
| Li₂O | — | 1 | — |
| B₂O₃ | 3 | 3 | — |
| ZnO | 3 | 1 | — |
| Na₂O | 18 | 14 | — |
| MgO | — | — | 20 |

TABLE 3

| | EXAMPLES | | | | |
|---|---|---|---|---|---|
| | 1 | 2 | 3 | 4 | 5 |
| main | Li₂O—Al₂O₃— | Li₂O—Al₂O₃— | Li₂O—Al₂O₃— | MgO— | ZnO— |
| component | SiO₂ | SiO₂ | SiO₂ | Al₂O₃— | Al₂O₃— |
| | | | | SiO₂ | SiO₂ |
| main | β-spodumene | β-quartz | β-spodumene | cordierite | Zn- |
| crystalline | solid solution | solid | solid solution | | petalite |
| phase | | solution | | | |
| thermal | 25 | 18 | 22 | 35 | 45 |
| expansion | | | | | |
| coefficient | | | | | |
| (×10⁻⁷/° C.) | | | | | |
| D | 0.04 | 0.08 | 0.05 | 0.12 | 0.14 |
| θ (°) | 73 | 66 | 71 | 60 | 57 |
| R(%) | 10.0 | 19.0 | 13.2 | 25.7 | 28.5 |
| L(dB/cm) | 1.0 | 4.1 | 5.6 | 5.6 | 5.6 |
| P(dB) | 0.2 | 0.4 | 0.3 | 0.5 | 0.5 |

TABLE 4

| | | | | COMPARATIVE | |
|---|---|---|---|---|---|
| | EXAMPLES | | | EXAMPLES | |
| | 6 | 7 | 8 | 9 | 10 |
| main | Na₂O— | Na₂O— | MgO—Al₂O₃— | ZrO₂ | B₂O₃—Al₂O₃— |
| component | Al₂O₃—SiO₂ | Al₂O₃—SiO₂ | SiO₂ | | SiO₂ |
| main | — | — | cordierite | ZrO₂ | — |
| crystalline | | | | | |
| phase | | | | | |
| thermal | 32 | 48 | 20 | 80 | 58 |
| expansion | | | | | |
| coefficient | | | | | |
| (×10⁻⁷/° C.) | | | | | |
| D | 0.03 | 0.04 | 0.15 | 0.38 | 0.03 |
| θ (°) | 78 | 73 | 55 | 18 | 78 |
| R(%) | 7.1 | 10.0 | 29.8 | 48.0 | 7.1 |
| L(dB/cm) | 0.6 | 0.8 | 6.5 | >7 | 0.02 |
| P(dB) | 0.3 | 0.4 | 0.4 | 1.2 | 1.0 |

In order to prepare the ceramic materials of Examples 1-5, raw materials were compounded to obtain the compositions shown in Tables 1 and 2. Each composition was melted at 1500° C. for 10 hours to form glass. The glass was heated at 1000° C. for 3 hours to perform crystallization. The main crystalline phases of the ceramic materials are shown in Tables 3 and 4.

In order to prepare the ceramic materials of Examples 6 and 7 comprising Na₂O—Al₂O₃—SiO₂ phase separated glass, raw materials were compounded to obtain the compositions shown in Table 2. Each composition was melted at 1500° C. for 10 hours to formglass. The glass was heated at 750° C. for 3 hours to separate phases.

The ceramic material of Example 8 comprising MgO—Al₂O₃—SiO₂ sintered ceramic was prepared by sintering compounded raw materials at 1400° C. for 10 hours.

A commercial ZrO₂ sintered ceramic for ferrules was used for the ceramic material of Comparative Example 9, and commercial B₂O₃—Al₂O₃—SiO₂ glass for ferrules was used for the ceramic material of Comparative Example 10.

Tables 3 and 4 show the following characteristics of the ceramic materials: the thermal expansion coefficient α, the absolute value D of the relative refractive index difference, the maximum incident angle θ where the reflectance of incident light (1550 nm) from silica glass to a ceramic material is less than 3%, the reflectance R at an incident angle of 80°, and the light attenuation coefficient L. When the θ is large and the R is small, the reflectance is small over a wide range of incident angles. When θ and R vary depending on the direction of the polarization of light, the largest values are employed.

The thermal expansion coefficient α was measured at a temperature of −40 to 100° C. with a dilatometer. The refractive index was measured with a refractometer using a minimum deviation. The θ and R were calculated according to Snell's laws of refraction and the Fresnel equations.

The characteristics of an optical device were evaluated using a fixed attenuator including metal ion-doped silica glass fibers.

With reference to FIG. 2, the description will be made about the fixed attenuator.

As the waveguide-adjacent member, a cylindrical body 11 was formed using a selected one of the above-mentioned ceramic materials. The cylindrical body 11 has an inner diameter of 0.126 mm, an outer diameter of 2.5 mm, and a length of 22 mm. As the waveguide member, a 25 dB-attenuating metal ion doped silica glass fiber 13 was inserted into a perforation 12 in the cylindrical body 11. The silica glass fiber 13 has an outer diameter of 0.125 mm and was fixed to the cylindrical body 11 with an epoxy adhesive. Both ends were mirror-polished to form convex faces to complete a fixed attenuator 10.

A single mode silica glass optical fiber was connected to each of the ends of the fixed attenuator 10 through a SC-type oprical connector. Light having a wavelength of 1550±50 nm was made to be incident on one end, and the stability of the attenuation of the fixed attenuator for each wavelength was then evaluated with an optical spectrum analyzer. That is, cyclic fluctuations of attenuation for wavelengths were observed, and the difference (range of fluctuation of attenuation) P between the maximum and the minimum of a fluctuation having the largest amplitude was recorded. The results are shown in Table 3 and 4. Since the range P of the fluctuation of attenuation is small, the interference of light leaking out of the waveguide and signal light is small, that is, the device has high performance.

As shown in Tables 3 and 4, since the ceramic materials of the example each have a thermal expansion coefficient of 48×10⁻⁷/° C. or less, the characteristics of the optical devices do not change much and are close each other. Since the ceramic materials of the example each have a D value of 0.15 or less, the 0 values are 550 or more and the R values are 29.8% or less. Furthermore, since the ceramic materials each have an L value of 0.6 dB/cm or more, the range P of the fluctuation of attenuation is 0.5 dB or less. Accordingly, the ceramic materials of the example are suitable for the waveguide-adjacent member included in the fixed attenuator.

In contrast, the ceramic material of Comparative Example 9 has an L value of 7 dB/cm or more. Since the D value is 0.38, which is large, the reflectance of the interface is large. Therefore, the range P of the fluctuation of attenuation is 1.2 dB, which is large. The ceramic material of Comparative Example 10 has a small D value and consequently provides preferable θ and R values. However, since the L value is 0.02 dB/cm, which is small, the range P of the fluctuation of attenuation is 1.0 dB, which is large.

### INDUSTRIAL APPLICABILITY

A ceramic material according to the present invention is applicable to waveguide adjacent members for optical connectors, optical attenuators, planar light circuits (PLC), and arrayed waveguides (AWG) because of its properties described above.

1. A ceramic material having a thermal expansion coefficient of less than 50×10⁻⁷/° C., an absolute value of the difference between the relative refractive indexes of silica glass and the ceramic material of 0.2 or less at a wavelength of 1550 nm, and a light attenuation coefficient of 0.3 dB/cm or more.

2. The ceramic material according to claim 1, being made of crystallized glass.

3. The ceramic material according to claim 1 or 2, comprising SiO₂, Al₂O₃, and Li₂O in a total amount of 45% or more on the basis of mass percentage.

4. The ceramic material according to any one of claims 1 to 3, said thermal expansion coefficient is less than 40×10⁻⁷/° C.

5. The ceramic material according to any one of claims 1 to 4, said light attenuation coefficient is of 0.5 dB/cm or more.

6. An optical device comprising the ceramic material according to any one of claims 1 to 5.
